(19) United States
(12) Patent Application Publication
(10) Pub. No.: US 2026/0094779 A1
(43) Pub. Date: Apr. 2, 2026

(54) IN-VEHICLE POWER SUPPLY DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takahiro OKAMOTO, Osaka (JP); Hiroki SHIMODA, Osaka (JP); Taiji YANAGIDA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 19/128,607

(22) PCT Filed: Nov. 8, 2023
(86) PCT No.: PCT/JP2023/040159

§ 371 Date: May 9, 2025

(30) Foreign Application Priority Data
Nov. 29, 2022 (JP) 2022-190199

(51) Int. Cl. H01H 47/00; B60L 58/10; H02J 7/00

(52) U.S. Cl. CPC H01H 47/002; B60L 58/10; H02J 7/855; H02J 2207/50

(57) ABSTRACT

An in-vehicle power supply device is used in an in-vehicle power supply system The in-vehicle power supply system includes a battery a power path to which power based on the battery is supplied, and a capacitor electrically connected to the power path The in-vehicle power supply device includes a first circuit (e.g., a precharge circuit and a second circuit (e.g., a relay circuit The first circuit (e.g., the precharge circuit performs a precharge operation of precharging the capacitor. The second circuit (e.g., the relay circuit has a configuration in which a plurality of relays (e.g., first relays are connected in parallel, and is provided on the power path closer to the battery than is the capacitor

### TECHNICAL FIELD

The present disclosure relates to an in-vehicle power supply device.

### BACKGROUND ART

In a battery system disclosed in Patent Document 1, after precharging by a precharge circuit, a relay that electrically connects a load device and a battery is closed. With this configuration, an inrush current flowing into the relay when the relay is closed can be suppressed.

### CITATION LIST

### Patent Documents

Patent Document 1: JP 2020-78196A

### SUMMARY OF INVENTION

### Technical Problem

However, even if the inrush current can be suppressed, deterioration of the relay progresses due to the relay repeatedly being turned on and off. When the deterioration of the relay progresses, eventually the relay will no longer be usable to be used, and replacement of a device including the relay will be required.

An object of the present disclosure is to provide a technique that easily extends the life of a device including a relay.

### Solution to Problem

An in-vehicle power supply device according to the present disclosure is an in-vehicle power supply device for use in an in-vehicle power supply system including a battery, a power path to which power based on the battery is supplied, and a capacitor electrically connected to the power path, the in-vehicle power supply device including:
a first circuit configured to perform a precharge operation of precharging the capacitor; and
a second circuit to be provided on the power path closer to the battery than is the capacitor,
wherein the second circuit has a configuration in which a plurality of relays are connected in parallel.

### Advantageous Effects of Invention

With the technique according to the present disclosure, the life of a device including a relay is easily extended.

### BRIEF DESCRIPTION OF DRAWINGS

FIG. 1 is a circuit diagram schematically showing an in-vehicle power supply system including an in-vehicle power supply device according to a first embodiment.

FIG. 2 is a diagram illustrating operations of the in vehicle power supply device when a first control is executed.

FIG. 3 is a diagram illustrating operations of the in vehicle power supply device when a second control is executed.

FIG. 4 is a diagram illustrating operations of the in-vehicle power supply device when a third control is executed.

FIG. 5 is a circuit diagram schematically showing an in-vehicle power supply system including an in vehicle power supply device according to a fourth embodiment.

### DESCRIPTION OF EMBODIMENTS

Embodiments of the present disclosure will be listed and described below.

[1] An in-vehicle power supply device for use in an in-vehicle power supply system including a battery, a power path to which power based on the battery is supplied, and a capacitor electrically connected to the power path, the in-vehicle power supply device including:
a first circuit configured to perform a precharge operation of precharging the capacitor; and
a second circuit to be provided on the power path closer to the battery than is the capacitor,
wherein the second circuit has a configuration in which a plurality of relays are connected in parallel.

With the above in-vehicle power supply device, it is possible to suppress flowing of the inrush current into a relay by switching the plurality of relays to an ON state after precharging the capacitor with the first circuit. Further, in the above in-vehicle power supply device, any one of the plurality of relays can be selectively used. In addition, with the in-vehicle power supply device, by switching the plurality of relays to the ON state at the same time, it is possible to suppress the inrush current flowing into the relays. For this reason, with the above in-vehicle power supply device, it is easy to extend the life of a device including a relay.

[2] The in-vehicle power supply device according to [1], further including a control unit configured to control the first circuit and the plurality of relays,
wherein the control unit
   executes a first control for causing the first circuit to perform the precharge operation when a start condition for starting charging and discharging of the battery is satisfied,
   executes a second control for stopping the precharge operation and switching one or more of the plurality of relays to be switched to an ON state when a first switching condition is satisfied during execution of the first control, and
   executes a third control for switching at least one of the relays in an OFF state to the ON state when a second switching condition is satisfied during execution of the second control.

With the in-vehicle power supply device, by switching only some of the relays to the ON state in the second control, it is possible to cause a current to flow between the battery and the capacitor via the relays while limiting the relays into which the inrush current flows to some of the relays. Furthermore, with the above in-vehicle power supply device, it is possible to increase the number of relays in the ON state by switching at least some of the relays in an OFF state to the ON state in a state where the battery and the capacitor are electrically connected via the relays. As a result, with the above in-vehicle power supply device, the current flowing through the relays can be reduced.

[3] The in-vehicle power supply device according to [1], further including a control unit configured to control the first circuit and the plurality of relays,
wherein the control unit causes the first circuit to perform the precharge operation when a start condition for starting charging and discharging of the battery is satisfied, and stops the precharge operation and switches two or more of the relays to be switched to the ON state at the same time when a switching condition is satisfied during the precharge operation.

With the above in-vehicle power supply device, by switching two or more relays to the ON state at the same time, it is possible to suppress the inrush current flowing into the relays.

[4] The in-vehicle power supply device according to [2] or [3], wherein when the relay to be switched is one of the plurality of relays, the control unit selects the relay to be switched in accordance with a predetermined order.

With the in-vehicle power supply device, since a relay to be switched is selected in accordance with a predetermined order, it is easy to uniformly deteriorate the relays.

[5] The in-vehicle power supply device according to [2] or [3],
wherein when the relay to be switched is one of the plurality of relays, the control unit determines and compares the degree of deterioration of each of the relays, and selects the relay to be switched based on a comparison result.

With the above in-vehicle power supply device, it is possible to reflect the comparison result of the degree of deterioration in the selection of the relay to be switched.

[6] The in-vehicle power supply device according to [5],
wherein the control unit selects the relay having the smallest degree of deterioration as the relay to be switched.

With the above in-vehicle power supply device, it is easy to deteriorate the relays uniformly, making it possible to realize the extension of the life of the device including the relays more reliably.

[7] The in-vehicle power supply device according to [5] or [6],
wherein the control unit measures a resistance value of each of the relays in the ON state as the determination of the degree of deterioration.

With the above in-vehicle power supply device, the resistance values of the relays in the ON state can be used as the degrees of deterioration.

### FIRST EMBODIMENT

### 1. Configuration of In-vehicle Power Supply System 100

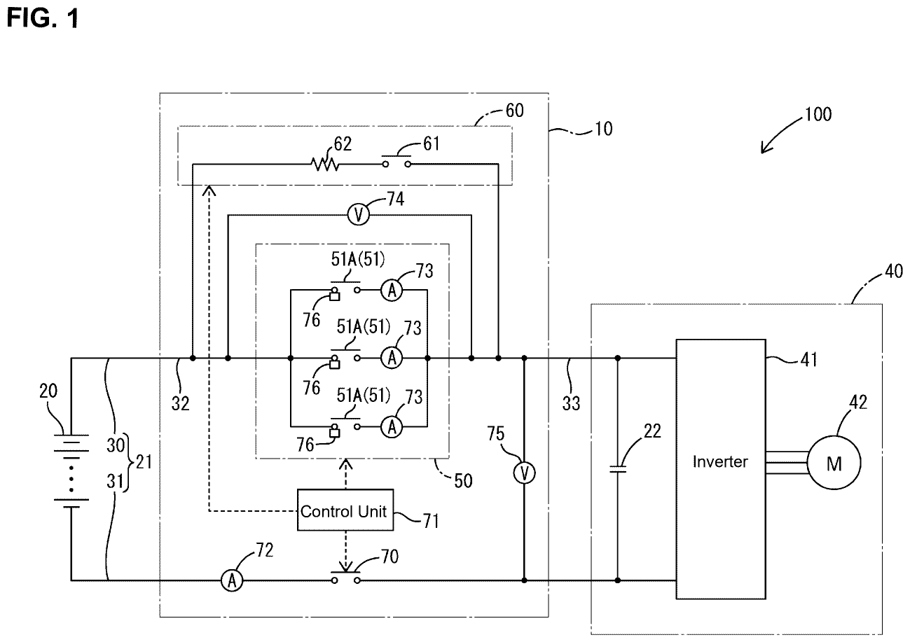

FIG. 1 shows an in-vehicle power supply system 100 including an in-vehicle power supply device 10. The in-vehicle power supply system 100 is used in a vehicle (not shown). The vehicle may be an electric car, engine powered vehicle, or a hybrid car. The in-vehicle power supply system 100 includes a battery 20, a power path 21, and a capacitor 22 as well as the in-vehicle power supply device 10.

The battery 20 may be a lithium ion battery, a lead battery, or another kind of battery.

The power path 21 is an electrical path to which power based on the battery 20 is supplied. The power path 21 includes a positive electrode side power line 30 and a negative electrode side power line 31. A terminal on the positive electrode side of the battery 20 is electrically connected to the positive electrode side power line 30. A terminal on the negative electrode side of the battery 20 is electrically connected to the negative electrode side power line 31. The negative electrode side power line 31 is electrically connected to the ground. An output voltage of the battery 20 is applied to the power path 21 (more specifically, the positive electrode side power line 30). In the present specification, the voltage is a potential difference with respect to the ground potential, and is a potential difference with respect to the negative electrode side power line 31.

The capacitor 22 is electrically connected to the power path 21. The capacitor 22 is provided between the positive electrode side power line 30 and the negative electrode side power line 31. One end of the capacitor 22 is electrically connected to the positive electrode side power line 30. The other end of the capacitor 22 is electrically connected to the negative electrode side power line 31. Power based on the battery 20 is supplied to the capacitor 22 via the power path 21. The capacitor 22 smooths a voltage based on the battery 20.

In the present embodiment, the capacitor 22 is configured as a part of a drive unit 40 provided in the in-vehicle power supply system 100. The drive unit 40 includes an inverter 41 and a motor 42 in addition to the capacitor 22. The capacitor 22 is provided closer to the battery 20 than is the inverter 41. The capacitor 22 smooths a voltage based on the battery 20 and supplies the smoothed voltage to the inverter 41. The inverter 41 is electrically connected to the power path 21. The inverter 41 generates an AC voltage (for example, a three phase AC) from a DC voltage based on a voltage supplied from the battery 20, and supplies the AC voltage to the motor 42. The motor 42 is, for example, a motor for a main engine system. The motor 42 is a device that rotates based on the power supplied from the battery 20 and applies a rotational force to the wheels of the vehicle.

The in-vehicle power supply device 10 is used in the in-vehicle power supply system 100. The in-vehicle power supply device 10 includes a relay circuit 50, a precharge circuit 60, and a second relay 70.

The relay circuit 50 corresponds to an example of a “second circuit”. The relay circuit 50 has a configuration in which a plurality of first relays 51 (more specifically, first relays 51A, 51B, and 51C) are connected in parallel. The first relays 51 correspond to an example of “relays”. The first relays 51 are system main relays. The first relays 51 are mechanical relays. The first relays 51 have contacts.

End portions on the battery 20 side of the plurality of first relays 51 are short-circuited to each other. End portions on the opposite side to the battery 20 side of the plurality of first relays 51 are short-circuited to each other. One end of each of the first relays 51 is electrically connected and short-circuited to the positive electrode of the battery 20. The other end of each of the first relays 51 is electrically connected and short-circuited to one end of the capacitor 22. When all the first relays 51 are in the OFF state, the relay circuit 50 blocks the current flow from the battery 20 to the capacitor 22 via the relay circuit 50. The relay circuit 50 brings the positive electrode of the battery 20 and the one end of the capacitor 22 into a conductive state when at least one of the first relays 51 is in the ON state. The relay circuit 50 allows a current to flow from the battery 20 to the capacitor 22 via the relay circuit 50 when at least one first relay 51 is in the ON state.

The above-described positive electrode side power line 30 includes a first positive electrode side power line 32 provided on the battery 20 side with respect to the relay circuit 50, and a second positive electrode side power line 33 provided on the opposite side to the battery 20 side with respect to the relay circuit 50.

The precharge circuit 60 performs a precharge operation for precharging the capacitor 22. The precharge circuit 60 is in parallel with the relay circuit 50. One end of the precharge circuit 60 is electrically connected to and short-circuited to the first positive electrode side power line 32. The other end of the precharge circuit 60 is electrically connected to and short-circuited to the second positive electrode side power line 33. The precharge circuit 60 has a configuration in which a precharge relay 61 and a resistance unit 62 are connected in series.

The precharge relay 61 is a mechanical relay. The precharge relay 61 has a contact. The resistance unit 62 is configured by, for example, a known resistor.

The second relay 70 is provided closer to the battery 20 than is the capacitor 22 on the power path 21. The second relay 70 is provided on the negative electrode side power line 31. One end of the second relay 70 is electrically connected and short-circuited to the negative electrode terminal of the battery 20. The other end of the second relay 70 is electrically connected and short-circuited to the other end of the capacitor 22. The second relay 70 is a system main relay. The second relay 70 is a mechanical relay. The second relay 70 has a contact.

### 2. Configuration of Control Unit 71

The in-vehicle power supply device 10 includes a control unit 71, a current detection unit 72, individual current detection units 73, a first voltage detection unit 74, a second voltage detection unit 75, and temperature detection units 76.

The control unit 71 includes, for example, a control circuit such as an integrated circuit. The control unit 71 includes a processing unit such as a CPU, a storage unit such as a memory, an input/output unit, and the like.

The current detection unit 72 is configured as, for example, a known current sensor. The current detection unit 72 detects a value of a current flowing through a path (more specifically, the negative electrode side power line 31) of the power path 21 excluding a portion where the relay circuit 50 and the precharge circuit 60 are connected in parallel. That is, when the current flows into only the relay circuit 50 out of the relay circuit 50 and the precharge circuit 60, the current detection unit 72 detects the current flowing through the relay circuit 50. When a current flows into only the precharge circuit 60 out of the relay circuit 50 and the precharge circuit 60, the current detection unit 72 detects the current flowing through the precharge circuit 60. The current detection unit 72 outputs a signal capable of specifying a detection value. The control unit 71 specifies the value of the current flowing through the power path 21 (more specifically, the negative electrode side power line 31) based on the output signal of the current detection unit 72. The control unit 71 specifies the current flowing through the precharge circuit 60, by specifying the detection value when the precharge circuit 60 is performing the precharge operation.

The individual current detection units 73 are configured as, for example, known current sensors. The individual current detection units 73 are individually provided for the respective first relays 51. Each individual current detection unit 73 detects the value of the current flowing through the corresponding first relay 51 when the first relay 51 is in the ON state. Each individual current detection unit 73 outputs a signal capable of specifying a detection value. The control unit 71 specifies the value of the current flowing through each first relay 51 based on the output signal of the corresponding individual current detection unit 73.

The first voltage detection unit 74 is configured as, for example, a known voltage detection circuit. The first voltage detection unit 74 detects the end-to-end potential difference of the relay circuit 50 (more specifically, the first relays 51). The first voltage detection unit 74 outputs a signal capable of specifying a detection value. The control unit 71 specifies the end-to-end potential difference of the first relays 51 based on the output signal of the first voltage detection unit 74.

The second voltage detection unit 75 is configured as, for example, a known voltage detection circuit. The second voltage detection unit 75 detects the voltage of the capacitor 22. The second voltage detection unit 75 outputs a signal capable of specifying a detection value. The control unit 71 specifies the voltage of the capacitor 22 based on the output signal of the second voltage detection unit 75.

The temperature detection units 76 are configured as, for example, known temperature sensors. The temperature detection units 76 are individually provided to the respective first relays 51. Each temperature detection unit 76 detects the temperature of the contact of the corresponding first relay 51. Each temperature detection unit 76 outputs a signal capable of specifying a detection value. The control unit 71 specifies the temperature of the contact of each first relay 51 based on the output signal of each temperature detection unit 76.

The control unit 71 controls the relay circuit 50, the precharge circuit 60, and the second relay 70. In other words, the control unit 71 controls the plurality of first relays 51, the precharge relay 61, and the second relay 70.

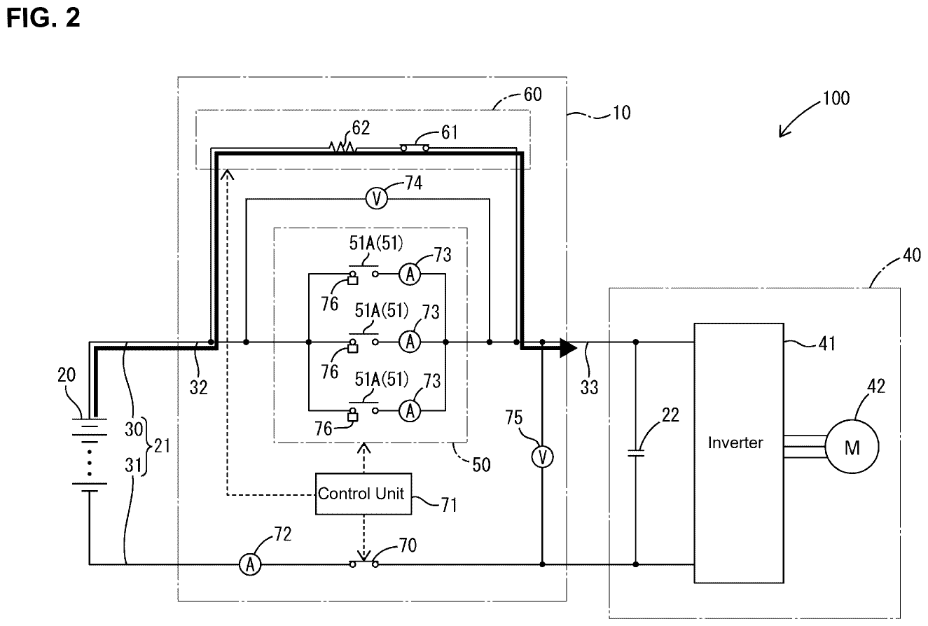

The control unit 71 performs a first control when a start condition for starting the charging and discharging of the battery 20 is satisfied. When the start condition is satisfied, all of the first relays 51, the precharge relay 61, and the second relay 70 are in the OFF state. The first control is a control for causing the precharge circuit 60 to perform the precharge operation. More specifically, as shown in FIG. 2, the first control is a control for switching the precharge relay 61 and the second relay 70 to the ON state while maintaining all the first relays 51 in the OFF state. In a state where the first control is performed, the power based on the battery 20 is supplied to the capacitor 22 via the precharge circuit 60. According to this configuration, the current flowing through the power path 21 is suppressed by the resistance unit 62 of the precharge circuit 60. Therefore, it is possible to increase the voltage of the capacitor 22 while suppressing damage to the first relays 51, the precharge relay 61, and the second relay 70. As the voltage of the capacitor 22 increases, the difference between the voltage of the capacitor 22 and the voltage of the battery 20 decreases. As a result, the end-to-end potential difference of the first relays 51 becomes small.

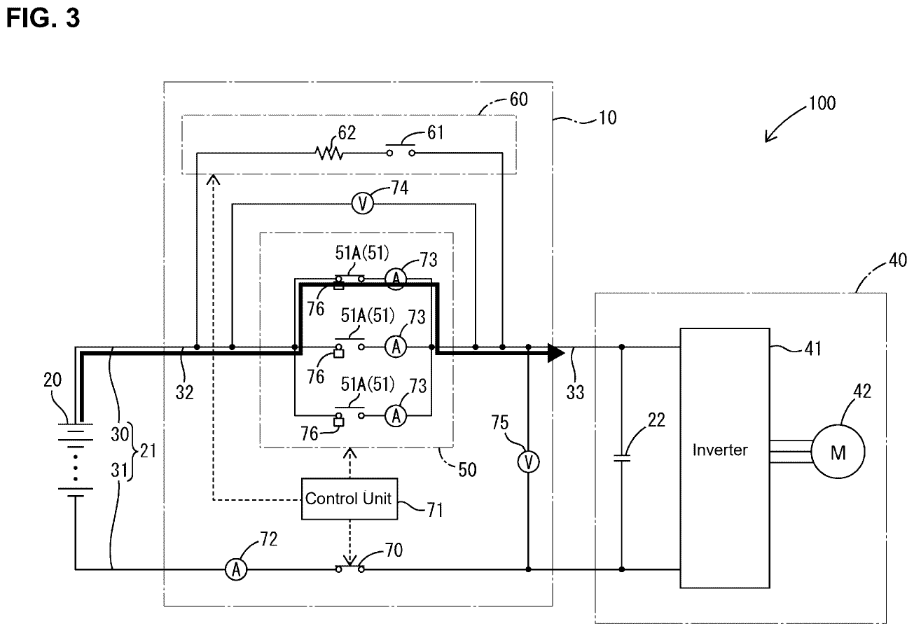

The control unit 71 executes a second control when a first switching condition is satisfied during the execution of the first control. The second control is control for stopping the precharge operation by the precharge circuit 60 and switching some of the first relays 51 to be switched among the plurality of first relays 51 to the ON state. More specifically, as shown in FIG. 3, the second control is control for switching the precharge relay 61 to the OFF state and switching the first relay 51 to be switched to the ON state while maintaining the second relay 70 in the ON state. In a state where the second control is performed, the positive electrode of the battery 20 is electrically connected to the one end of the capacitor 22 via the relay circuit 50 (more specifically, the first relay 51), and the positive electrode of the battery 20 is short-circuited to the one end of the capacitor 22. As a result, the voltage of the battery 20 becomes substantially equal to the voltage of the capacitor 22 in a short time, and the end-to-end potential difference of the first relays 51 approaches 0 V.

The first switching condition may be that the end-to-end potential difference of the first relays 51 becomes less than or equal to a predetermined value, may be that the value of the current flowing through the precharge circuit 60 becomes less than or equal to a predetermined value, may be that a predetermined time has elapsed from the start of the first control, may be that the voltage of the capacitor 22 becomes greater than or equal to a predetermined value, or may be other conditions.

The number of the first relays 51 to be switched may be some of the first relays 51 constituting the relay circuit 50, and may be one first relay or two or more first relays.

The control unit 71 selects the first relay 51 to be switched in accordance with a predetermined order. For example, the control unit 71 may select the first relay 51 to be switched in the order of the first relay 51A, the first relay 51B, and the first relay 51C. In this case, for example, the control unit 71 selects the first relay 51A for the current second control and the first relay 51B for the next second control. In this case, the control unit 71 switches the first relay 51 to be switched every time the first switching condition is satisfied. Alternatively, the control unit 71 may switch the first relay 51 to be switched each time a predetermined condition is satisfied. The predetermined condition may be, for example, that the first relay 51 to be switched has been continuously switched to the ON state a predetermined number of times, that the degree of deterioration of the first relay 51 to be switched has exceeded a threshold value, or may be other conditions. The degree of deterioration will be described in detail later. The predetermined order may be changeable.

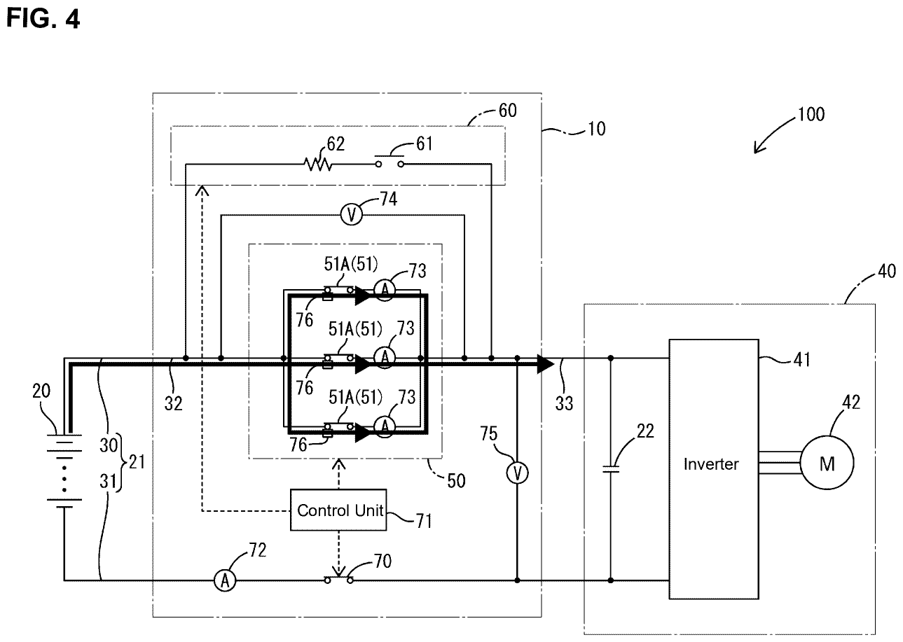

The control unit 71 executes a third control when a second switching condition is satisfied during the execution of the second control. The third control is control for increasing the number of first relay 51 in the ON state. More specifically, the third control is control for switching at least some of the first relay 51 in the OFF state to the ON state. For example, as shown in FIG. 4, the control unit 71 switches all the first relays 51 in the OFF state to the ON state in the third control. That is, the control unit 71 controls all the first relays 51 to be in the ON state in the third control. In a state where the third control is performed, a current flows through the power path 21 via the plurality of first relays 51 that are controlled to be in the ON state.

The second switching condition is preferably a condition that is satisfied when the end-to-end potential difference of the first relays 51 becomes approximately 0 V. The second switching condition may be that the end-to-end potential difference of the first relays 51 becomes a predetermined value or less, that the value of the current flowing through the precharge circuit 60 becomes a predetermined value or less, may be that a predetermined time has elapsed from the start of the first control, that the voltage of the capacitor 22 becomes a predetermined value or more, or may be other conditions.

### 3. Degree of Deterioration

The degree of deterioration of each first relay 51 is specified based on, for example, the end-to-end potential difference of the first relays 51 when all the other first relays 51 are in the OFF state and the target first relay 51 is in the ON state (hereinafter, also referred to as a “the end-to-end potential difference of the first relay 51”), a value of a current flowing through the first relay 51, a resistance value when the first relay 51 is in the ON state, the number of times of operation of the first relay 51, a temperature of a contact when the first relay 51 is in the ON state, a combination of a plurality of these, and the like. The degree of deterioration of each first relay 51 may be the value itself illustrated above, or may be a value obtained by substituting the value illustrated above into an arithmetic expression. The temperature of the contact when the first relay 51 is in the ON state depends not only on the degree of deterioration (for example, the resistance value) of the first relay 51 but also on the value of the current flowing through the first relay 51. Therefore, in the configuration in which the degree of deterioration of the first relay 51 is specified based on the temperature of the contact when the first relay 51 is in the ON state, the degree of deterioration of the first relay 51 is preferably specified based on the temperature of the contact when the first relay 51 is in the ON state and the value of the current flowing through the first relay 51.

The degree of deterioration of the first relay 51 increases as the end-to-end potential difference of the first relay 51 increases. The degree of deterioration of the first relay 51 increases as the value of the current flowing through the first relay 51 decreases. The degree of deterioration of the first relay 51 increases as the resistance value of the first relay 51 in the ON state increases. The degree of deterioration of the first relay 51 increases as the number of operations of the first relay 51 increases. Assuming that the value of the current flowing through the first relay 51 is constant, the degree of deterioration of the first relay 51 increases as the temperature of the contact when the first relay 51 is in the ON state increases.

As a method of specifying the end-to-end potential difference of the first relay 51, for example, the control unit 71 sequentially switches the first relay 51 to the ON state and specifies the end-to-end potential difference of the first relay 51 when each first relay 51 is turned to the ON state. The timing of starting the specification may be, for example, during execution of the third control.

As a method of specifying the value of the current flowing through each first relay 51, for example, the control unit 71 specifies the value of the current flowing through each first relay 51 based on the output signal of the corresponding individual current detection unit 73. As another example, the control unit 71 sequentially switches the first relays 51 to be turned to the ON state, and specifies the value of the current flowing through each first relay 51 based on the output signal of the current detection unit 72 when the first relay 51 is turned to the ON state. The timing of starting the specification may be, for example, during execution of the third control.

As a method of specifying the resistance value when the first relays 51 are in the ON state, for example, the control unit 71 specifies the end-to-end potential difference of the first relay 51 and the value of the current flowing through the first relays 51 by the above-described method. Then, the control unit 71 specifies the resistance value of each first relay 51 based on the specified potential difference and value of the current. The timing of starting the specification may be, for example, during execution of the third control.

As a method of specifying the number of times of operation of the first relays 51, for example, the control unit 71 counts the number of times of switching to the ON state in the second control for each first relay 51.

As a method of specifying the temperature of the contact when the first relay 51 is in the ON state, the control unit 71 specifies the temperature of the contact when each first relay 51 is in the ON state, based on the output signal of the corresponding temperature detection unit 76, for example.

### 4. Example of Effects

In the in-vehicle power supply device 10, an inrush current can be suppressed from flowing into the first relays 51 by switching the first relays 51 to the ON state after the capacitor 22 is precharged by precharge circuit 60. In addition, the in-vehicle power supply device 10 can selectively use any of the plurality of first relays 51. Therefore, with the in-vehicle power supply device 10, a long life of a device including the first relays 51 can be easily achieved.

By switching only some of the first relays 51 to the ON state in the second control, the in-vehicle power supply device 10 can cause a current to flow between the battery 20 and the capacitor 22 via the first relays 51 while limiting the first relays 51 through which the inrush current flows to some of the first relays 51. Furthermore, the in-vehicle power supply device 10 can increase the number of the first relays 51 in the ON state, by switching at least some of the first relays 51 from the OFF state to the ON state in a state where a current can flow between the battery 20 and the capacitor 22 via the first relays 51. As a result, with the in-vehicle power supply device 10, the current flowing through the first relays 51 can be reduced.

In the in-vehicle power supply device 10, since the first relay 51 to be switched is selected in accordance with a predetermined order, it is easy to uniformly deteriorate the first relays 51.

With the in-vehicle power supply device 10, the resistance value of each first relay 51 in the ON state can be measured as the determination of the degree of deterioration. According to this configuration, in the in-vehicle power supply device 10, it is possible to use the resistance value of each first relay 51 in the ON state as the degree of deterioration.

### SECOND EMBODIMENT

In the first embodiment, the first relays 51 to be switched are selected in a predetermined order. On the other hand, in a second embodiment, a configuration will be described in which the degrees of deterioration of the first relays 51 are determined and compared with each other, and the first relay 51 to be switched is selected based on the comparison result. The second embodiment will mainly describe the difference from the first embodiment. The in-vehicle power supply system of the second embodiment has the same configuration as that in FIG. 1 illustrated in the first embodiment. Accordingly, the second embodiment will be described below with reference to FIG. 1.

In the second embodiment, the control unit 71 determines the degrees of deterioration of the first relays 51. Then, the control unit 71 compares the determined degrees of deterioration, and selects the first relay 51 to be switched based on the comparison result. More specifically, the control unit 71 selects the first relay 51 with the smallest degree of deterioration as the first relay 51 to be switched. When the number of switching targets is two or more, the control unit 71 selects two or more first relays 51 in ascending order of the degree of deterioration. For example, when the number of switching targets is two, the control unit 71 selects the two first relays 51 with the smallest degree of deterioration.

With the in-vehicle power supply device 10 of the second embodiment, the comparison result of the degree of deterioration can be reflected in the selection of the first relay 51 to be switched. Furthermore, with the in-vehicle power supply device 10 of the second embodiment, since the first relays 51 can be easily uniformly deteriorated, it is possible to more reliably achieve a long life of a device including the first relays 51.

### THIRD EMBODIMENT

In a third embodiment, a configuration in which the control unit 71 switches two or more first relays 51 to be switched to the ON state at the same time will be described. In the third embodiment, differences from the first embodiment will be mainly described. The in-vehicle power supply system of the third embodiment has the same configuration as that of FIG. 1 described in the first embodiment. Therefore, the third embodiment will be described with reference to FIG. 1.

In the third embodiment, in the second control, the control unit 71 stops the precharge operation by the precharge circuit 60 and switches the two or more first relays 51 to be switched to the ON state at the same time. That is, the control unit 71 causes the precharge circuit 60 to perform the precharge operation when the start condition for starting the charging and discharging of the battery 20 is satisfied, and stops the precharge operation and switches the two or more first relays 51 to be switched to the ON state at the same time when the first switching condition is satisfied during the precharge operation.

In the first embodiment and the second embodiment, the number of first relays 51 to be switched is some of the first relays 51 constituting the relay circuit 50. In contrast, in the third embodiment, the number of the first relays 51 to be switched may be all of the first relays 51 constituting the relay circuit 50.

In-vehicle power supply device 10 of the third embodiment can suppress an inrush current flowing through each first relay 51 by switching two or more first relays 51 to the ON state at the same time.

### FOURTH EMBODIMENT

A fourth embodiment will describe an example in which the precharge operation is performed by a DC-DC converter instead of the precharge circuit 60. The same components as those of the first embodiment are denoted by the same reference numerals, and detailed description thereof will be omitted.

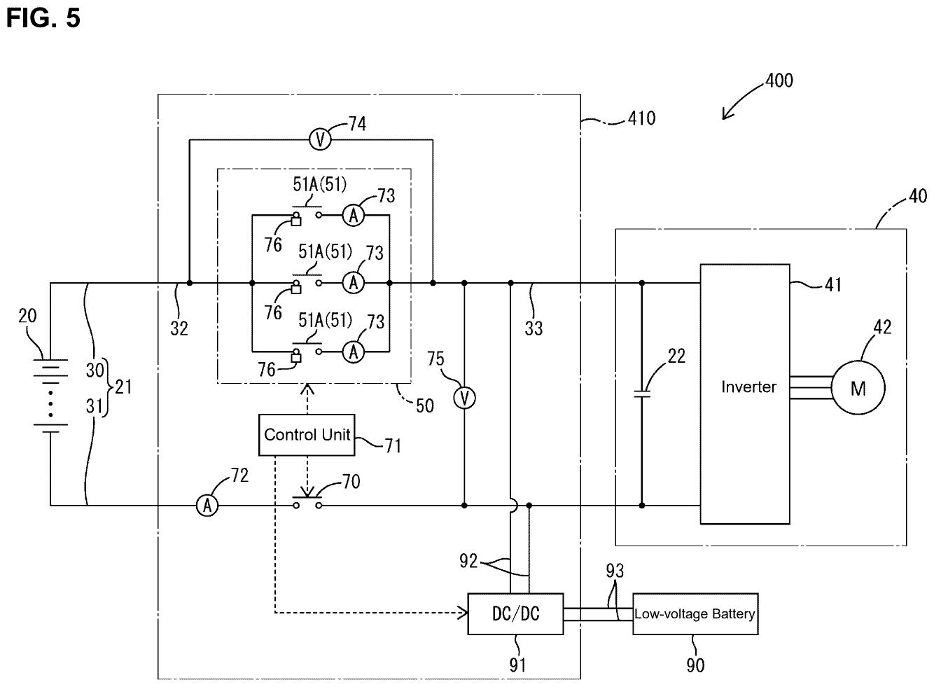

An in-vehicle power supply system 400 of the fourth embodiment shown in FIG. 5 is different from the in-vehicle power supply system 100 of the first embodiment in that the precharge circuit 60 is not included and a low-voltage battery 90 and a DC-DC converter 91 are included, and is common to the in-vehicle power supply system 100 in other respects.

The in-vehicle power supply system 400 of the fourth embodiment includes the battery 20, the power path 21, the capacitor 22, the low-voltage battery 90, and an in-vehicle power supply device 410.

The low-voltage battery 90 is a battery having a lower output voltage when fully charged than the battery 20. That is, the battery 20 can be said to be a “high-voltage battery”. The low-voltage battery 90 may be a lead battery, a lithium-ion battery, or another battery.

The in-vehicle power supply device 410 includes the relay circuit 50, the second relay 70, the control unit 71, the current detection unit 72, the individual current detection units 73, the first voltage detection unit 74, the second voltage detection unit 75, the temperature detection units 76, and the DC-DC converter 91.

The DC-DC converter 91 corresponds to an example of the “first circuit”. The DC-DC converter 91 performs a first operation of converting (in the present embodiment, “stepping down”) a voltage applied to a first conductive path 92 and applying the resultant voltage to a second conductive path 93. Further, the DC-DC converter 91 performs a second operation of converting (in the present embodiment, “boosting”) a voltage applied to the second conductive path 93 and applying the resultant voltage to the first conductive path 92. The first conductive path 92 is electrically connected to the power path 21, and is electrically connected to the capacitor 22 via the power path 21. The first conductive path 92 is short-circuited to the capacitor 22. The low-voltage battery 90 is connected to the second conductive path 93.

The control unit 71 controls the DC-DC converter 91. The control unit 71 charges the low-voltage battery 90 by causing the DC-DC converter 91 to perform the first operation when power is being supplied from the battery 20 to the power path 21. “When power is being supplied from the battery 20 to the power path 21” is when at least one of the first relays 51 is in the ON state and the second relay 70 is in the ON state.

By causing the DC-DC converter 91 to perform the second operation, the control unit 71 boosts the voltage based on the low-voltage battery 90 and applies the boosted voltage to the first conductive path 92. A voltage is applied to the capacitor 22 based on the voltage applied to the first conductive path 92. That is, the DC-DC converter 91 can perform a precharge operation of precharging the capacitor 22. In the precharge operation, the DC-DC converter 91 raises the voltage of the capacitor 22 to a voltage substantially equal to the voltage of the battery 20. That is, an operation of raising the voltage of the capacitor 22 to a voltage substantially equal to the voltage of the battery 20 by the second operation is the precharge operation.

When the start condition is satisfied, the control unit 71 causes the DC-DC converter 91 to perform the precharge operation. Thereafter, when the first switching condition described in the first embodiment is satisfied, the control unit 71 controls the DC-DC converter 91 to stop the precharge operation and switches the first relay 51 and the second relay 70 to the ON state. Some or all of the first relays 51 may be switched to the ON state. When some of the first relays 51 are switched to the ON state, the third control described in the first embodiment may be executed thereafter.

With the in-vehicle power supply device 410 of the fourth embodiment, the capacitor 22 can be precharged using the DC-DC converter 91 that charges the low-voltage battery 90. Therefore, the precharge circuit 60 described in the first embodiment is not required. In the case of the precharge circuit 60, the voltage of the capacitor 22 is less likely to rise as the voltage of the capacitor 22 becomes closer to the voltage of the battery 20. On the other hand, in the configuration using the DC-DC converter 91, the voltage of the capacitor 22 can be quickly raised to the voltage of the battery 20.

### Other Embodiments

The present disclosure is not limited to the embodiments described above and illustrated in the drawings. For example, the features of the embodiments described above or below can be combined in any manner as long as no contradiction occurs. In addition, any of the features of the embodiments described above or below may be omitted if not explicitly described as being essential. Furthermore, the above-described embodiments may be modified as follows.

In the above embodiments, the second relay 70 does not need to be provided.

In the above embodiments, the third control does not need to be executed.

In the first embodiment, the relay circuit 50 and the precharge circuit 60 are provided on the positive electrode side power line 30, but the relay circuit 50 and the precharge circuit 60 may be provided on the negative electrode side power line 31.

The embodiments disclosed here are to be considered in all respects as illustrative and not limiting. The present invention is not intended to be limited to these embodiments, but rather is indicated by the scope of the claims, and is intended to include all modifications within the scope of equivalents of the claims.

### LIST OF REFERENCE NUMERALS

10 In-vehicle power supply device
20 Battery
21 Power path
22 Capacitor
30 Positive electrode side power line
31 Negative electrode side power line
32 First positive electrode side power line
33 Second positive electrode side power line
40 Drive unit
41 Invertor
42 Motor
50 Relay circuit (second circuit)
51 First relay (relay)
51A First relay (relay)
51B First relay (relay)
51C First relay (relay)
60 Precharge circuit (first circuit)
61 Precharge relay
62 Resistance unit
70 Second relay
71 Control unit
72 Current detection unit
73 Individual current detection unit
74 First voltage detection unit
75 Second voltage detection unit
76 Temperature detection unit
90 Low-voltage battery
91 DC-DC converter (first circuit)
92 First conductive path
93 Second conductive path
100 In-vehicle power supply system
400 In-vehicle power supply system
410 In-vehicle power supply device

1. An in-vehicle power supply device for use in an in-vehicle power supply system including a battery, a power path to which power based on the battery is supplied, and a capacitor electrically connected to the power path, the in-vehicle power supply device comprising:
a first circuit configured to perform a precharge operation of precharging the capacitor; and
a second circuit provided on the power path closer to the battery than the capacitor is,
wherein the second circuit has a configuration in which a plurality of relays are connected in parallel.

2. The in-vehicle power supply device according to claim 1, further comprising a control unit configured to control the first circuit and the plurality of relays,
wherein the control unit
executes a first control for causing the first circuit to perform the precharge operation when a start condition for starting charging and discharging of the battery is satisfied,
executes a second control for stopping the precharge operation and switching one or more of the plurality of relays to be switched to an ON state when a first switching condition is satisfied during execution of the first control, and
executes a third control for switching at least one of the relays in an OFF state to the ON state when a second switching condition is satisfied during execution of the second control.

3. The in-vehicle power supply device according to claim 1, further comprising a control unit configured to control the first circuit and the plurality of relays,
wherein the control unit causes the first circuit to perform the precharge operation when a start condition for starting charging and discharging of the battery is satisfied, and stops the precharge operation and switches two or more of the relays to be switched to the ON state at the same time when a switching condition is satisfied during the precharge operation.

4. The in-vehicle power supply device according to claim 2, wherein when the relay to be switched is one of the plurality of relays, the control unit selects the relay to be switched in accordance with a predetermined order.

5. The in-vehicle power supply device according to claim 2,
wherein when the relay to be switched is one of the plurality of relays, the control unit determines and compares the degree of deterioration of each of the relays, and selects the relay to be switched based on a comparison result.

6. The in-vehicle power supply device according to claim 5,
wherein the control unit selects the relay having the smallest degree of deterioration as the relay to be switched.

7. The in-vehicle power supply device according to claim 5,
wherein the control unit measures a resistance value of each of the relays in the ON state as the determination of the degree of deterioration.
